(19) United States
(12) Patent Application Publication
(10) Pub. No.: US 2010/0262273 A1
(43) Pub. Date: Oct. 14, 2010

(54) Method and apparatus for the manufacture of pouches

(75) Inventors: Thomas Dose, Itzehoe (DE); Andreas Storcks, Hamburg (DE); Hagen Geske, Rotenburg (DE)

Correspondence Address: SMITH, GAMBRELL & RUSSELL, SUITE 3100, PROMENADE II, 1230 PEACHTREE STREET, N.E., ATLANTA, GA, 30309-3592, US

(73) Assignee: Focke & Co. (GmbH & Co. KG), VERDEN (DE)

(21) Appl. No.: 12/699,353

(22) Filed: Feb. 3, 2010

(30) Foreign Application Priority Data
Feb. 9, 2009 (DE) 102009008129.1

(51) Int. Cl. G06F 19/00

(52) U.S. Cl. 700/122; 700/212

(57) ABSTRACT

The invention relates to a method for the manufacture of pouches (30) from foil (44) or the like for bulk goods or fibrous material, preferably for tobacco (31), wherein a continuous foil web (44) and/or at least one further continuous material web (41) are guided along at least one welding station (45, 46, 47, 104), at which portions of the foil (33a) (and/or of the at least one further material (41) are welded, preferably to other portions of the foil (34a) and/or to the further material (41), in particular to parts of a multiaction sealing means (41). In this method, the foil web (44) and/or the at least one further material web (41) are guided, in particular cyclically, at least approximately in a vertical direction along the at least one welding station (45, 46, 47, 104), and/or the continuous foil web (44) and/or the at least one further material web (41) are welded, in particular cyclically, by ultrasonic welding.

The present invention relates to a method for the manufacture of pouches from foil or the like for bulk goods or fibrous material, preferably for tobacco, wherein a continuous foil web and/or at least one further continuous material web are guided along at least one welding station, at which portions of the foil and/or of the at least one further material are welded, preferably to other portions of the foil and/or to the further material, in particular to parts of a multiaction sealing means. The invention further relates to an apparatus for implementation of the method. The invention additionally relates to a welding apparatus which can be used, in particular, in connection with the aforesaid manufacturing method.

The invention is primarily concerned with the manufacture of pouch packages for cut tobacco. Such a pouch consists of a generally heat-weldable or heat-sealable foil, which, where necessary, is of multiply or multilayered configuration. Within the scope of the invention, portions of the foil are generally welded together by means of heating jaws. It is known to provide such pouches with pressure seals, for example Zip-Locks®. These multiaction sealing means are likewise heat-welded to the foil during manufacture.

The previous manufacturing methods have several drawbacks. Firstly, the heat-welding of the foil and/or of the pressure seals is relatively time-demanding, resulting in long machine cycle times. Furthermore, the materials to be welded expand during the introduction of heat. This applies particularly to welding operations directly relating to the foil. In the prior art, furthermore, the foil runs horizontally during the welding operations. Despite suitable pretensioning of the foil, this frequently sags downward under gravitational force, namely in the direction of the welding jaws disposed beneath the foil. Particularly when the coating on the welding jaws diminishes, the foil then remains stuck to the welding jaws. Where applicable, the foil printing is thereby destroyed.

The object of the present invention is to improve the manufacturing method for pouch packages with a view to a production which is as problem-free as possible.

This object is achieved by a method having the features of Claim 1 and an apparatus having the features of Claim 11.

The method according to the invention or the apparatus according to the invention is characterized, according to a first embodiment, in that the foil web and/or the at least one further material web are guided, in particular cyclically, at least approximately in a vertical direction along the at least one welding station. The guidance of the foil web and/or of the material web in the vertical direction, while the welding operations are taking place, optimally prevents problematic influences of gravitational force upon the pouch manufacture. A downward sagging of the foil—as is the case in the horizontal conveyance of the foil in the prior art—is effectively prevented.

Additionally or alternatively, the manufacture of the pouches can be effectively improved by the configuration of at least one welding station as an ultrasonic welding station. In the present case, the ultrasonic welding station offers a host of advantages over thermal welding methods. The duration of the individual welding processes can thus be markedly reduced in relation to thermal welding operations. Furthermore, the expansions of the foil and/or of the further material, generated by the introduction of heat, are prevented.

According to a preferred embodiment of the invention, the or each welding station has welding jaws, in particular ultrasonic sonotrodes, which in a horizontal plane are respectively moved up to at least one of the materials to be welded, so that the welding jaws, during the actual welding operation, particularly during the application of pressure, bear against the respective material.

According to a further, preferred embodiment of the invention, at least two, preferably three and/or all welding stations, are arranged in a common vertical plane consecutively in the direction of conveyance of the foil web, preferably one below the other.

According to a further, preferred embodiment of the invention, preferably at a first welding station, a multiaction pressure seal, as the sealing means, is is fastened to the foil web, preferably by ultrasonic welding.

According to a further, preferred embodiment of the invention, in particular at a second welding station, which is preferably arranged downstream of the first welding station, individual portions of profiled strips of the pressure seal are fused or welded together, preferably by ultrasonic welding.

According to a further, preferred embodiment of the invention, in particular at a third welding station, which is preferably arranged downstream of the second welding station, individual portions of the foil are welded together, preferably by ultrasonic welding, with the formation of cross seams extending substantially transversely to the direction of conveyance of the foil web.

According to a further, preferred embodiment of the invention, the fusion or welding together both of the individual portions of the profiled strip and of the individual portions of the foil for the formation of the cross seams is realized at one and the same welding station, the respective welding operations preferably taking place concurrently.

According to a further, preferred embodiment of the invention, the foil web is guided without deflection between the welding stations rectilinearly in an at least approximately vertical direction along at least two, preferably along all welding stations.

According to a further, preferred embodiment of the invention, the pressure seal has two profiled strips, which can be detachably connected to each other and which, as continuous profiled strips, in the mutually connected state, namely the closed state of the pressure seal, are fed into the path of conveyance of the foil web, which are subsequently separated—opened state of the pressure seal—and which subsequently, in the separated state, are respectively welded individually to the foil.

According to a further, preferred embodiment of the invention, the pressure seal, for the separation of the connected profiled strips, is conveyed to a separating diverter, which separates the pressure seal into the two profiled strips, whereupon the two profiled strips, following the separation and prior to the welding together of the same, are conveyed onward along the separating diverter.

According to a further, preferred embodiment of the invention, the separating diverter has to both sides bearing surfaces, against which the separated profiled strips bear during the welding operation, the welding jaws of the welding station being arranged opposite to the bearing surfaces.

According to a further, preferred embodiment of the invention, the profiled strips are positioned during the welding operation respectively in a groove within the respective bearing surfaces.

According to a further, preferred embodiment of the invention, the position of the continuous foil web and/or of the pressure seal is registered by means of a suitable sensor, in particular by means of a printed mark reader, the position of the foil web relative to the welding jaws of at least one welding station being controlled and/or regulated in dependence on the measurement values registered by the sensor.

According to a further, preferred embodiment of the invention, the pressure seal has two profiled strips, which can be detachably connected to each other and which, as continuous profiled strips, in the mutually connected state, namely the closed state of the pressure seal, are fed into the path of conveyance of the foil web, and which subsequently, in the mutually connected state, are respectively welded to the foil.

According to a further, preferred embodiment of the invention, the, in the closed state of the pressure seal, mutually opposing strips respectively have at least one carrier strip to be welded to the foil, which carrier strip respectively, during the welding operation, bears at least in some areas against bearing means disposed in at least one interspace between the carrier strips, those sides of the respective carrier strip which are facing the interspace(s) here bearing at least in some areas against the respective bearing means.

According to a further, preferred embodiment of the invention, at least two welding jaws, in particular ultrasonic sonotrodes, are arranged opposite one another in a horizontal plane, the welding jaws, in particular during the welding operation, being moved uniformly up to or away from each other in relation to a vertical center plane running between the welding jaws, and these motions being mutually synchronized by means of a suitable synchronizing device.

An apparatus according to the invention for the achievement of the object has the features of Claim 11. According to this, an apparatus for the manufacture of pouches from foil or the like for bulk goods or fibrous material, preferably for tobacco, is defined, comprising a conveying device with which a continuous foil web and/or a further continuous material web can be guided along at least one welding station of the apparatus, wherein the welding station is configured such that, at this, portions of the foil and/or of the at least one further material can be welded, preferably to other portions of the foil and/or to the further material, in particular to parts of a multiaction sealing means, and wherein the conveying device and the welding station are configured and arranged such that the foil web can be guided along the at least one welding station at least approximately in a vertical direction, and/or wherein the welding station is configured as an ultrasonic welding station.

According to, a further, preferred embodiment of the invention, the conveying device comprises at least one conveying means, preferably a conveying roller, having at least one conveying surface, which latter possesses at least one groove in which one or more continuous profiled strips of a sealing means configured as a pressure seal can be guided.

According to a further, preferred embodiment of the invention, the welding station has welding jaws, in particular ultrasonic sonotrodes, which are arranged such that they are movable in an at least approximately horizontal plane, in particular driven by a motor drive, for instance a hydraulic or pneumatic drive.

According to a further, preferred embodiment of the invention, at least two, preferably three and/or all welding stations, are arranged consecutively downstream of one another in a common vertical plane in the direction of conveyance of the foil web, preferably one below the other.

According to a further, preferred embodiment of the invention, at least one welding station possesses a plurality of welding units, arranged consecutively downstream of one another and arranged, in particular, one below the other in a vertical plane and respectively having at least one welding jaw, in particular an ultrasonic sonotrode, the welding units of the welding station being disposed on a common frame or rack, preferably on a closed frame/rack.

According to a further, preferred embodiment of the invention, at least one welding station possesses a plurality of welding unit pairs, in particular arranged one below the other in the vertical plane and respectively having at least one welding jaw, the welding units of a welding unit pair being positioned one opposite the other in relation to the feed motion of the foil web at a common feed position and in relation to a center plane between the welding units, in particular in a common horizontal plane.

According to a further, preferred embodiment of the invention, the vertical positions of the welding jaws, in particular of the ultrasonic sonotrodes or of the welding units, in particular relative to each other, are adjustable by means of at least one actuator, in particular by means of a common spindle, which is respectively operatively connected to the welding units and can be driven by motorized or manual means.

According to a further, preferred embodiment of the invention, the spindle drive possesses at least two portions having different thread pitches, at least a first welding unit being operatively connected to the portion of smaller thread pitch and at least one further welding unit being operatively connected to the portion of larger thread pitch.

According to a further, preferred embodiment of the invention, the welding units of the welding station, for the guidance of the same during the vertical adjustment motions of the units, are guided within a preferably common, in particular vertically running groove of the common frame or rack.

Further features and advantages of the invention, which are also independently claimable, emerge from the appended patent claims, the following description of preferred illustrative embodiments of the invention and from the appended drawings, wherein:

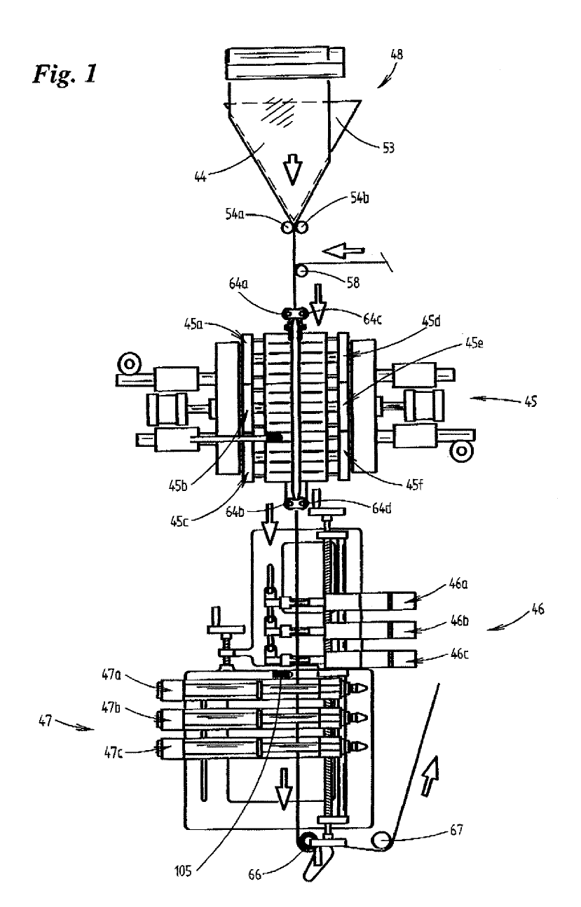

FIG. 1 shows a sub-portion of a pouch packer operating according to the method according to the invention, in schematic side view,

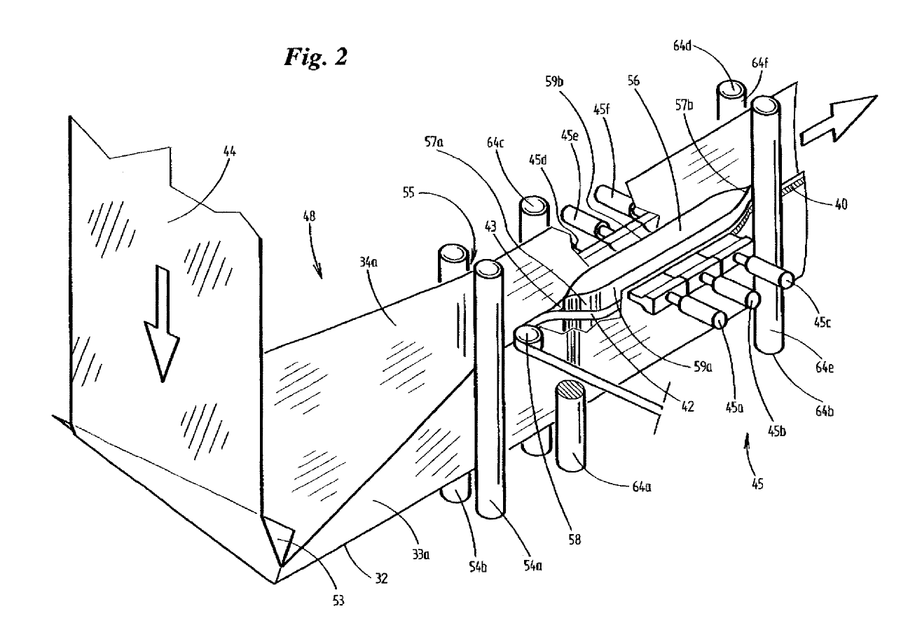

FIG. 2 shows a sub-detail from the representation from FIG. 1 in perspective oblique view, namely a first welding station of the pouch packer,

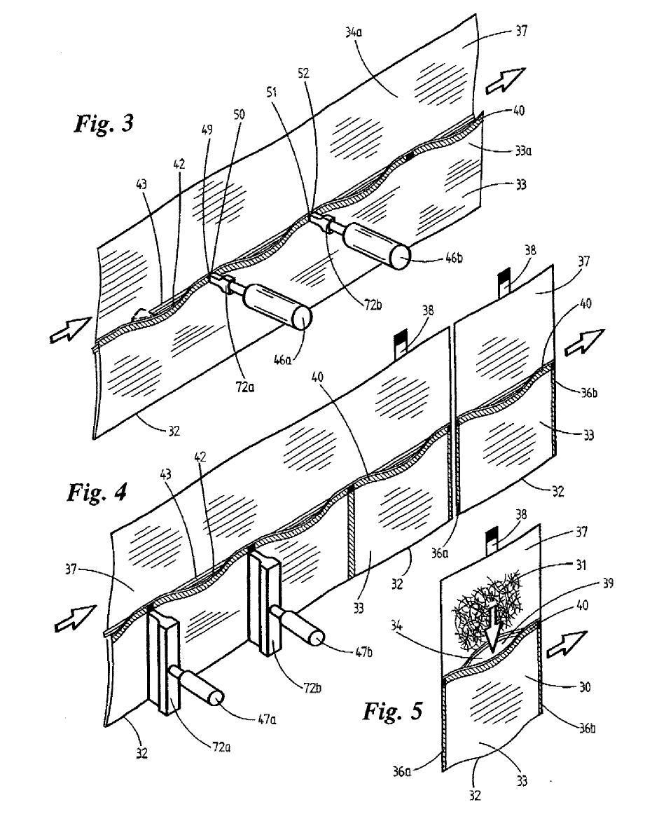

FIG. 3 shows a further sub-detail from the representation from FIG. 1 in once again simplified perspective representation, namely a second welding station,

FIG. 4 shows a further sub-detail from the representation from FIG. 1 in simplified perspective view, namely a third welding station,

FIG. 5 shows an individual tobacco pouch manufactured according to the invention, in oblique view,

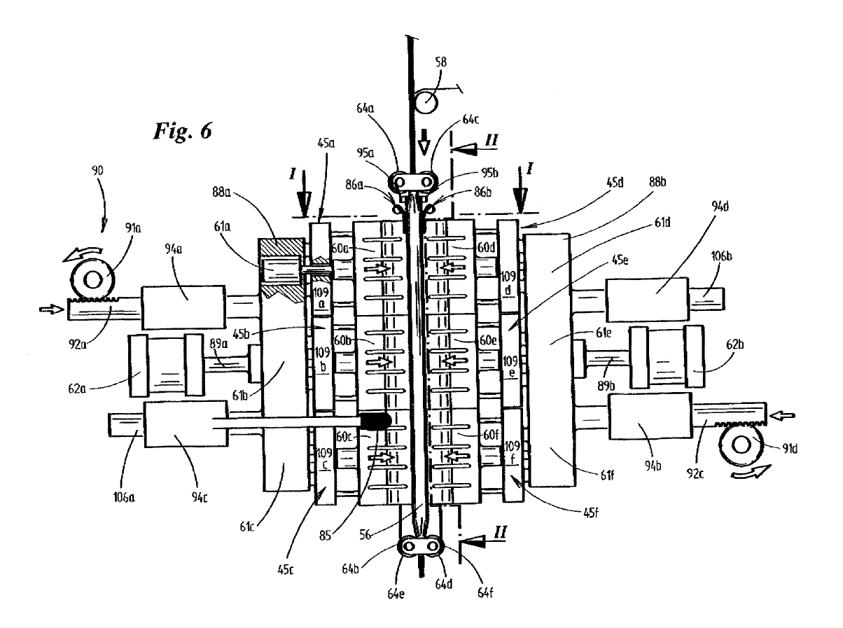

FIG. 6 shows the first welding station from FIG. 1 in schematic side view,

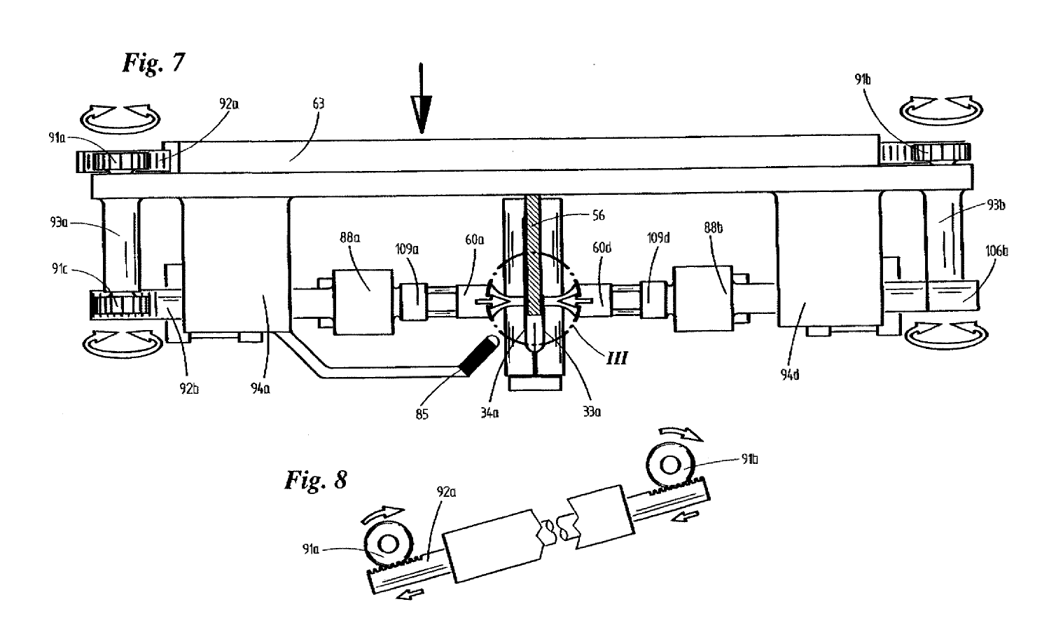

FIG. 7 shows a sectional view of the welding station from FIG. 6 along the sectional line I-I in FIG. 6,

FIG. 8 shows a specific detail of the welding station from FIG. 7, namely a part of a synchronous drive,

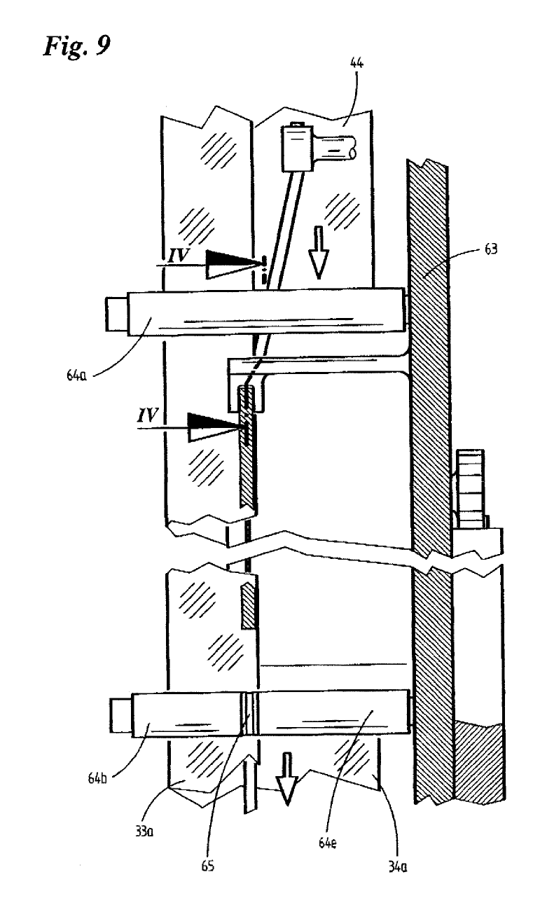

FIG. 9 shows a sectional representation of the first welding station from FIG. 6, along the sectional line II-II in FIG. 6,

FIG. 10 shows a section along the sectional line IV-IV in FIG. 9,

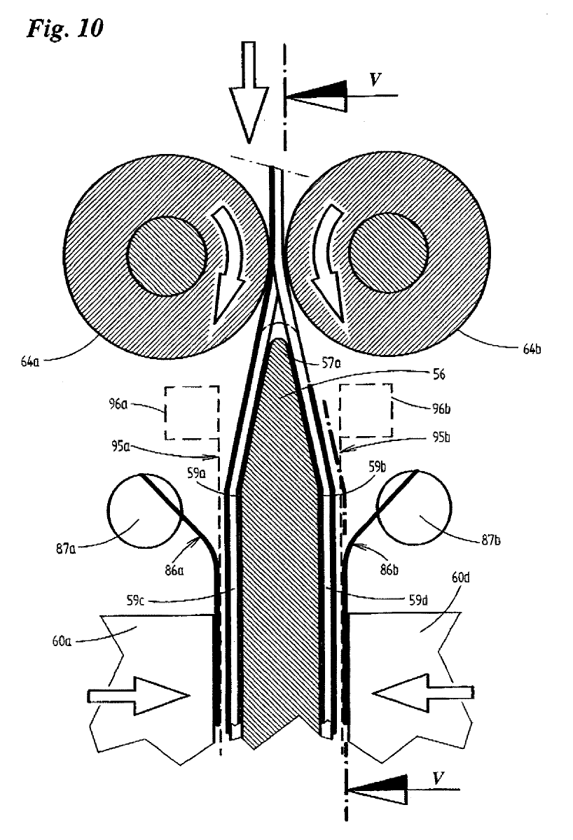

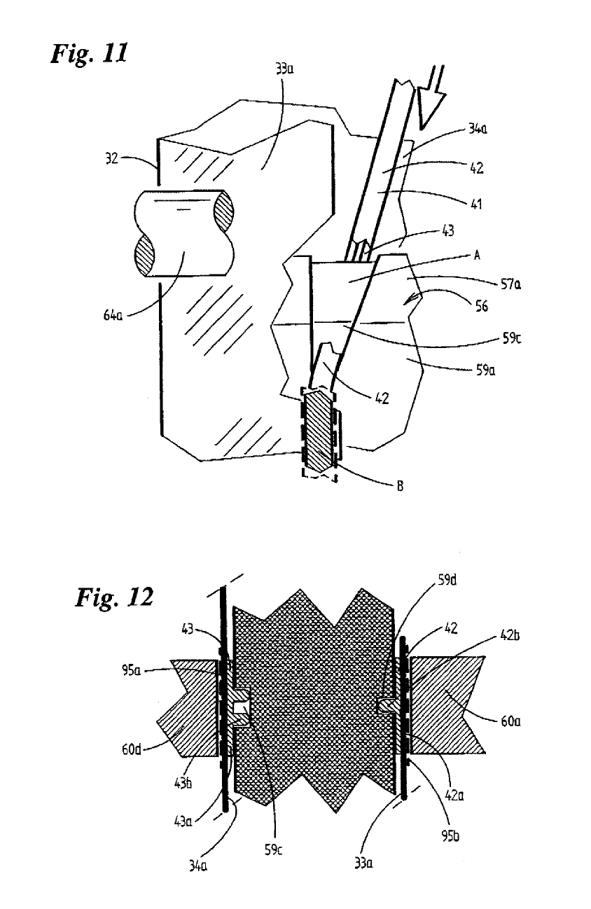

FIG. 11 shows a section along the sectional line V-V in FIG. 10,

FIG. 12 shows the detail III from FIG. 7,

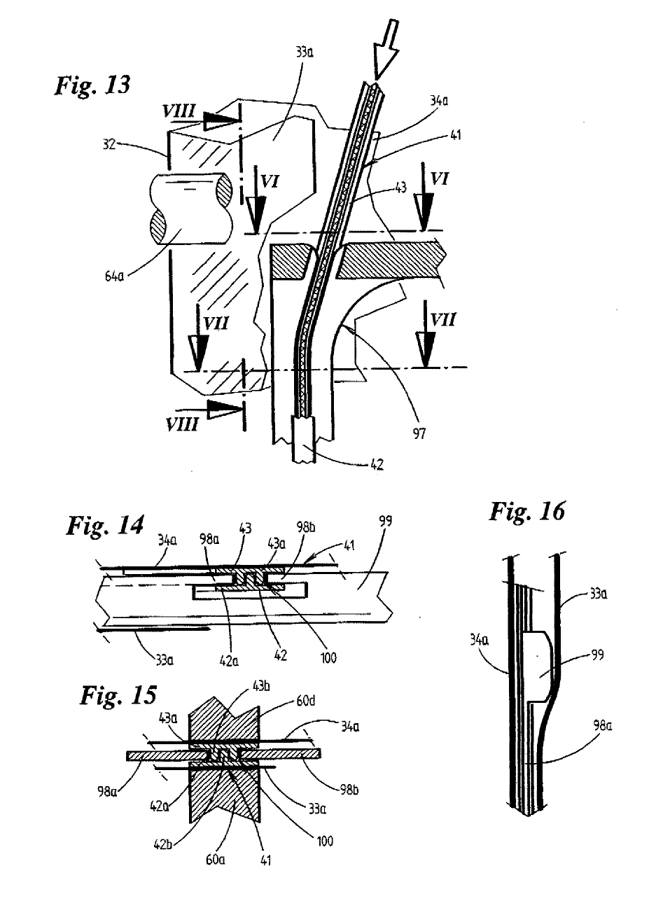

FIG. 13 shows an alternative embodiment of the first welding station from FIG. 6 in a sectional view analogous to the sectional line V-V in FIG. 9,

FIG. 14 shows a section along the sectional line VI-VI from FIG. 13,

FIG. 15 shows a section along the sectional line VII-VII from FIG. 13,

FIG. 16 shows a section along the sectional line VIII-VIII from FIG. 13,

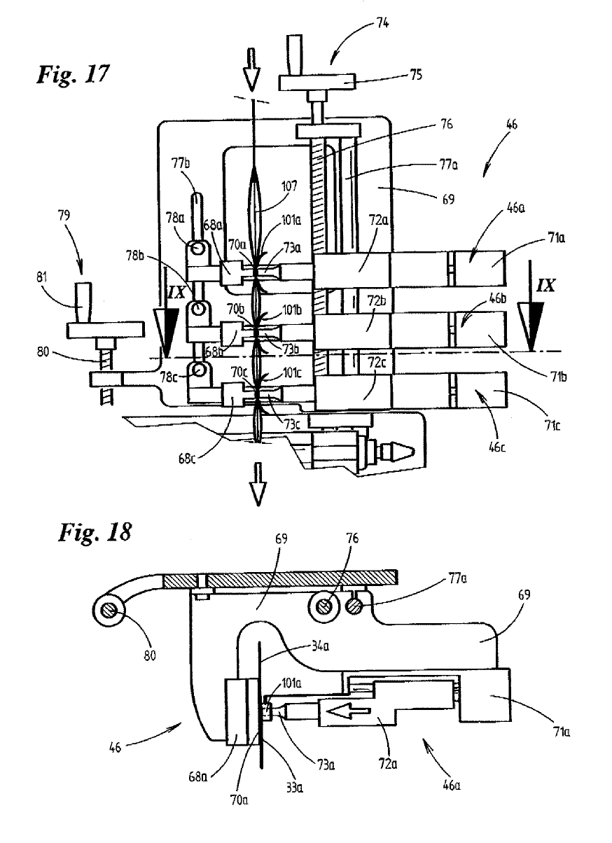

FIG. 17 shows the second welding station from FIG. 1 in schematic side view,

FIG. 18 shows a section through the second welding station along the sectional line IX-IX from FIG. 17,

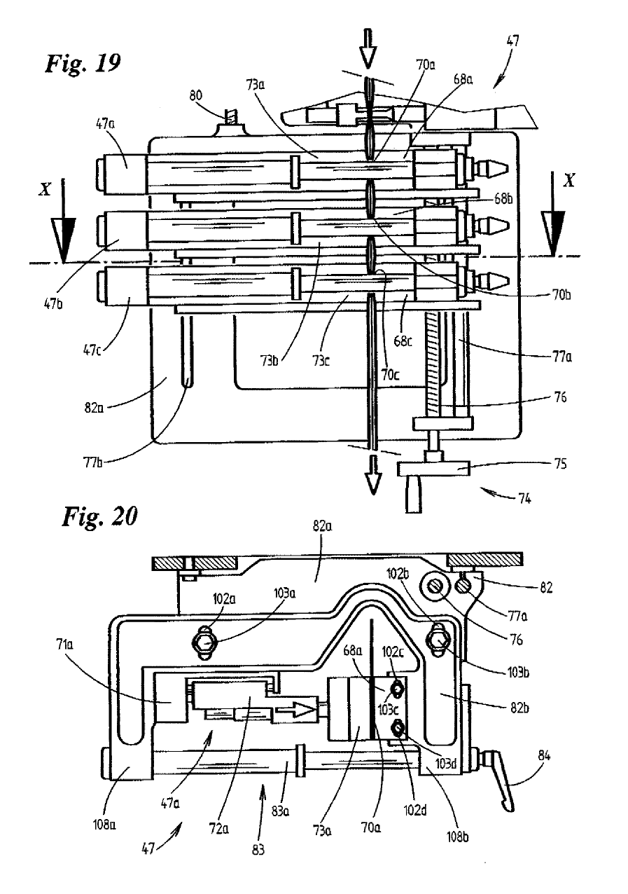

FIG. 19 shows the third welding station from FIG. 1 in schematic side view,

FIG. 20 shows a section through the third welding station along the sectional line X-X in FIG. 19,

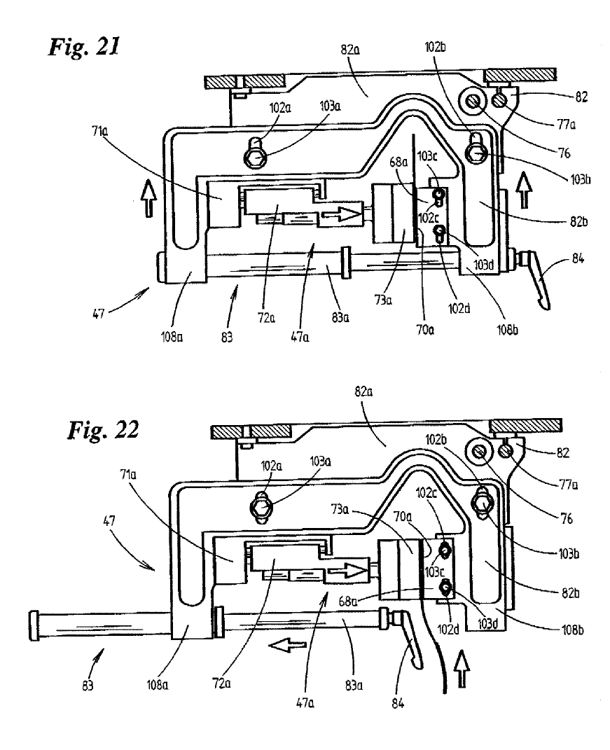

FIG. 21 shows the third welding station in the representation according to FIG. 19, with altered bearing device,

FIG. 22 shows the third welding station in the representation according to FIG. 19, with displaced tie rod,

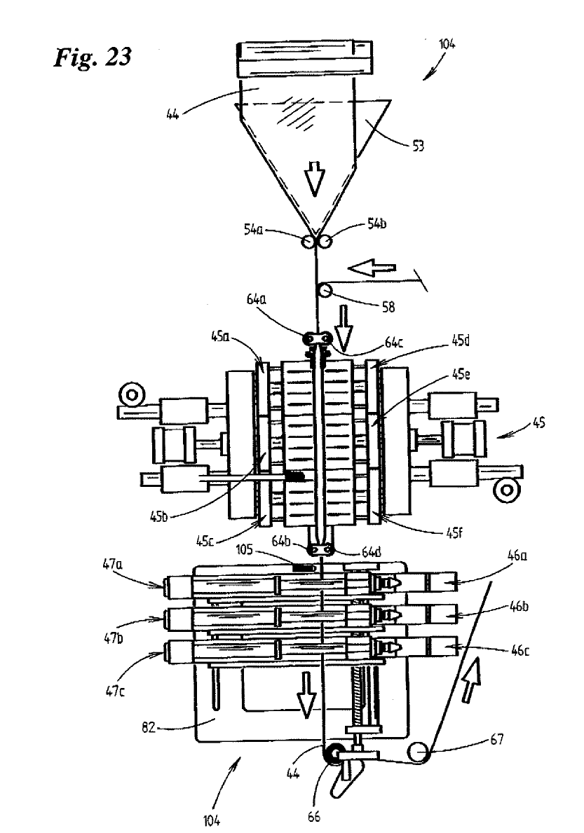

FIG. 23 shows a further embodiment of the invention in schematic side view, in which, in relation to the embodiment from FIG. 1, the second and third welding station are functionally combined in one station,

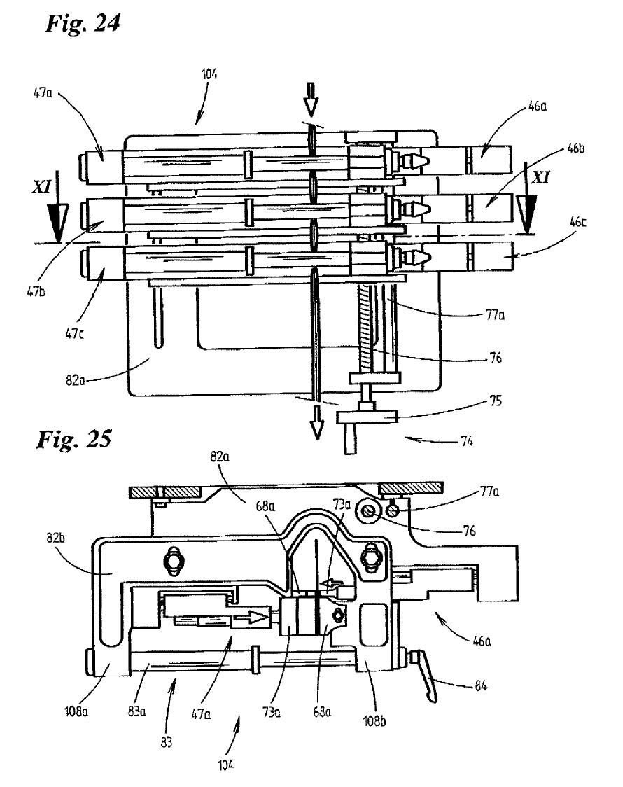

FIG. 24 shows the combined welding station from FIG. 23 in side view,

FIG. 25 shows a section through the welding station from FIG. 23 along the sectional line XI-XI in FIG. 24.

The represented illustrative embodiments relate to the manufacture of pouches 30 from foils, namely of tobacco pouches. In such a pouch 30, one or more tobacco portions 31 are filled as the pouch content. The pouch 30 consists of thin packaging material, in particular of a foil which is sealable or weldable with ultrasound and/or heat. A blank for the formation of a pouch is folded, with the formation of a bottom edge 32, in such a way that a front wall 33 and a rear wall 34 lie one against the other or form the pouch 30 for the reception of the tobacco portion. In the region of side edges, the front wall 33 and the rear wall 34 are permanently connected, namely welded, to each other, to be precise by upright side seams 36a, 36b. The rear wall 34 of the pouch 30 is provided with an extension or continuation for the formation of an envelope flap 37. With closed pouch 30, the envelope flap 37 is folded down against the front wall 33 and is detachably connected thereto, for example by means of an adhesive strip 38.

The pouch 30 has a fill opening 39. This extends transversely to the pouch 30 and is delimited by the front wall 33 and the rear wall 34. It is located on an upper longitudinal seam 40 of the pouch 30 or of the front wall 33.

The fill opening 39 is at the same time a removal opening. Following filling of the pouch 30 with the tobacco portion 31, the fill and/or removal opening 39 is closed by a multiaction sealing means 41. The multiaction sealing means 41 can hence first be opened later by a user during use, and re-closed following the removal of part-portions.

As the multiaction sealing means 41, a pressure seal is positioned in the region of the fill or removal opening 39. In the present case, the pressure seal 41 is a so-called Zip-Lock®.

The sealing means 41 possesses two profiled strips 42, 43, which in the closed state of the sealing means 41 are connected to each other. By pulling apart of the same, these can be separated from each other for opening of the sealing means 41. In order to later reconnect the profiled strips 42, 43 or in order to later reseal the sealing means 41, the profiled strips 42, 43 are placed one against the other and subjected to lateral pressure.

For this purpose, each profiled strip 42, 43 possesses a carrier strip 42a and 43a and respectively connecting profiles 42b and 43b connected preferably integrally thereto. The profiled strips 42, 43 are formed from a material which is weldable by means of ultrasound. They are connected, in a manner explained in greater detail below, by welding to the front wall 33 and the rear wall 34. The connection is such that the connecting profiles 42b, 43b of the respective profiled strips 42, 43 lie beneath the fill and/or removal opening 39.

In the position in which the profiled strips 42, 43 are connected to each other, i.e. the fill and/or removal opening 39 is closed, the rib-like connecting profiles 42b, 43b pass reciprocally in positive-locking engagement one into the other and thus form an effective, easy-to-open connection over the full extent of the fill and/or removal opening 39.

In a particular manner, the manufacture of the pouches is realized by means of a pouch packer configured according to the invention. Below, various stations of the pouch packer are represented, in which, in particular, the welding of the pouches 30 takes place, the connection of the profiled strips 42, 43 to the front wall 33 and rear wall 34, and the fusion of ends of the profiled strips 42, 43 of the pouch 30. Other stations, on the other hand, which are not relevant according to the invention, inter alia the division of a continuous foil web into the individual pouches 30, the application of the adhesive strips 38 to the pouches 30, the filling of the pouches 30 with the tobacco portions 31, have been omitted for reasons of simplification.

According to a first embodiment of the method according to the invention and of the apparatus according to the invention, a continuous, first material web 44, namely a foil web, is conveyed in the vertical direction from top to bottom cyclically along three consecutive welding stations 45, 46, 47, cf. FIG. 1. Parallel to the first material web 44 is guided, at least in portions, a second material web, namely the sealing means 41 configured as a continuous material web.

For the conveyance of the material webs 41, 44, various rollers and rolls are provided, in particular deflection rollers 58, 67, a motor-driven draw rolls 66, and guide rolls 64a, 64b, 64c, 64d. These individual conveying members are described in still greater detail below.

The material webs 41, 44 are conveyed onward by the conveying members cyclically at discrete time intervals, respectively by a specific feed portion, in the direction of conveyance. To this end, the draw roll 66 is suitably controlled by means of a central control and/or regulating device (not represented) of the apparatus or of the pouch packer. The draw roll 66 is here arranged downstream of the last, namely the third welding station 47.

The control of the same is realized in dependence on printed marks on the material web 41, which are registered by a printed mark reader 105. The printed mark reader 105 is disposed, for this purpose, between the second and third welding station 46 and 47.

Between the cyclical feed motions, the material webs 41, 44 remain stationary. In these idle phases, individual welding operations are carried out at the fixed welding stations 45, 46, 47.

Alternatively to the above procedure, it is also in principle conceivable to conduct the welding operation during continuous feed motions of the material webs 41, 44.

Each of the welding stations 45, 46, 47 possesses individual welding units 45a-45f, 46a-46c and 47a-47c. Respectively three individual welding units 45a-45c, 45d-45f, 46a-46c, and 47a-47c, are respectively arranged consecutively in the direction of conveyance (arrow direction in FIG. 1). In the present case, they are positioned one below the other.

All welding units 45a- . . . -47c of the three welding stations here execute, cyclically, horizontal to and/or fro motions up to and/or away from the material webs 41, 44. The welding units 45a- . . . -47c are cyclically moved to and/or fro between a position remote from the welding setting and the actual welding setting.

The inventive vertical alignment of the material webs 41, 44, in particular in the region of the welding station 45, 46, 47, offers the advantage, in contrast to a horizontal alignment, that a gravity-induced sagging of the same is prevented.

Accordingly, in particular, the danger is reduced that the foil web 44, as a result of the hanging, remains inadvertently stuck to the welding units 45a- . . . -47c and is erroneously carried along during the to and/or fro motions of the respective welding unit 45a- . . . -47c.

In a manner which is later described in still greater detail, the individual continuous profiled strips 42, 43 of the continuous sealing means web 41 are applied at the first welding station 45.

At the second welding station 46, in the later, completed pouches 30, mutually opposing end portions 49-52 of the profiled strips 42, 43 are fused together (“crashed”).

At the third sealing station 47, cross seams 35 are produced. Later, the continuous foil web 44 is divided into the individual pouches 30 by the execution—not shown—of parting cuts through the middle of these cross seams 35. The cross seam strips produced by the parting cuts then respectively form the side seams 36a and 36b connecting the front and rear wall 33, 34 of the completed pouches 30.

Before the continuous foil web 44 of the first welding station 45 is supplied, the web 44 which is initially guided in one plane is folded by means of a folding device 48, forming the (continuous) bottom edge 32 of the later pouches 30 (FIG. 2).

The folding device 48 comprises a folding triangle 53 and, downstream from this, two mutually spaced guide rollers 54a, 54b having parallel rotational axes which run perpendicular to the direction of conveyance of the foil web 44 and enclose a guide gap 55. Through this guide gap 55, the foil web 44 runs in already folded-over state.

From the, starting from the bottom edge 32, front region 33a of the continuous foil web 44, shown in FIG. 2, the front wall 33 of the later pouches 30 is formed. From the, starting from the bottom edge 32, rear region 34a of the foil web 44, which rear region runs at an angle to the front region 33a, the rear wall 34 and the envelope flap 37 of the later pouches 30 are formed.

In relation to the direction of conveyance of the material webs 41, 44, upstream of the first welding station 45, in the present case directly before the latter, the continuous sealing means web 41 is fed into the path of conveyance of the foil web 44.

In the present illustrative embodiment, the sealing means web 41 is conveyed for this purpose out of a direction at an angle to, in particular transversely to, the direction of conveyance of the foil web 44 into the path of conveyance of the same. More accurately, the sealing means web 41, from the side adjacent to the front foil region 33a, is fed into the path of conveyance in such a way that the sealing means web 41, after the feed-in, runs initially in a vertical plane between the front and the rear foil web region 33a, 34a.

For this purpose, in the region of the path of conveyance, offset to the longitudinal top edge of the front foil web region 33a, there is arranged a deflection roller 58, which deflects the sealing means web 41 into the (vertical) direction of conveyance of the foil web 44. The deflection roller 58 is here arranged in the region of the path of conveyance of the foil web 44 at a greater distance from the bottom edge 32 of the foil web 44 than is the longitudinal top edge of the front foil web region 33a of the foil web 44. In FIG. 2, the deflection roller 58 is therefore positioned above the longitudinal top edge of the front region 33a of the foil web 44.

The foil web 44 and the sealing means web 41, following the feed-in of the sealing means web 41 into the path of conveyance of the foil web 41, are jointly conveyed onward by two mutually opposing guide rolls 64a, 64c arranged upstream of the welding units 45a-45f. The rotary motions of the guide rolls 64a, 64c rotating about parallel axes are here synchronized. The foil web and the sealing means web 41 are moved onward between the guide rolls 64a, 64c by means of gentle contact pressure.

During the described conveyance between the roll pair 64a, 64c, the sealing means web 41 or the sealing means is still in the closed state. Accordingly, the profiled strips 42, 43 are mutually connected in the manner which is already described above.

In preparation for the following welding operation at the welding station 45, the profiled strips 42, 43, in a first embodiment of the invention (FIGS. 1-12), are separated from each other. For this purpose, they are conveyed along a separating diverter 56, which is disposed in the path of conveyance and adjoins, directly downstream, the guide roll pair 64a, 64c.

The separating diverter 56 possesses a separating means 57a, namely a free end of the separating diverter 56 which has a wedge-shaped taper. The separating means 57a acts roughly centrally between the mutually connected profiled strips 42, 43 and splits these into the individual strips 42, 43.

The separating diverter 56 has an all in all elongate contour. Downstream of the free end 57a, the separating diverter 56 possesses on two opposite longitudinal sides lateral bearing surfaces 59a, 59b running in the vertical plane of conveyance. The front foil web region 33a is conveyed jointly with the profiled strip 42 along the, in FIG. 2, front bearing surface 59a, the rear foil web region 34a together with the profiled strip 43 along the rear bearing surface 59b.

More accurately, the profiled strips 42, 43 are guided along guide grooves 59c, 59d recessed in the bearing surfaces 59a, 59b. Starting from those sides of the wedge-shaped free end 57a which run in the vertical plane, these guide grooves run along the lateral bearing surfaces 59a, 59b of the separating diverter 56 up to a further, wedge-shaped free end 57b of the separating diverter 56.

For the welding of the profiled strips 42, 43, these must first be fed into a specific setting relative to the front wall 33 or rear wall 34 of the later pouch 30. The profiled strip 42 must run parallel to the longitudinal top edge of the later front wall 33, to be precise somewhat beneath the same. The profiled strip must be positioned correspondingly at the same height on the opposite side of the rear wall 34.

Since the sealing means web 41 has initially been fed into the path of conveyance laterally offset to the front wall 33 or to the front foil web region 33 from which the front wall 33 is formed—in FIG. 2, therefore, above the longitudinal top edge of the front wall 33—the sealing means web 41 or the separated profiled strips 42, 43 must be redirected, prior to the welding, initially somewhat downward, i.e. in the direction of the bottom edge 32. In other words, the respective distances of the profiled strips 42, 43 from the bottom edge 32 must be reduced.

For this purpose, the guide grooves 59c, 59d of the separating points 56 respectively have a first portion A, which is inclined in the direction of the bottom edge 32 and by which the respective profiled strip 42, 43 is steered in the direction of the bottom edge 32.

This first portion A of the respective guide groove 59c, 59d is adjoined downstream by a second portion B running parallel to the bottom edge 32.

In other words, the portions A, B of the guide grooves 59c, 59d run in such a way that the profiled strips 42, run respectively parallel to the sealing means parent web at a distance therefrom, though at lesser distance from the bottom edge 32 (FIG. 2, FIG. 11).

The respective dimensions of the guide grooves 59c, 59d, in particular the widths and depths, are matched to the dimensions of the connecting profiles 42b, 43b of the profiled strips 42, 43. As can be clearly seen, in particular, in FIG. 11, the guide grooves 59c, 59d are respectively configured in such a way that the connecting profiles 42b and 43b come to lie within the guide grooves 59c, 59d. The carrier strips 42a, 43a, on the other hand, rest respectively outside the guide grooves 59c, 59d directly on those regions of the bearing surfaces 59a and 59b which surround or delimit the grooves 59c and 59d.

The rolls of the guide roll pair 64b, 64d arranged downstream of the welding units 45a-45f respectively possess, on their peripheral faces 64e, 64f, a guide groove 65 running, in particular, centrally in the peripheral direction. Accordingly, during the joint conveyance of foil web 44 and sealing means web 41 through the roll pair 64b, 64d, the profiled strip 42 of the sealing means web 41 comes to lie directly in the guide groove 65 of the guide roll 64b. Resting in the guide groove 65 of the opposite guide roll 64d, on the other hand, is a portion of the rear region 34a of the foil web 44, and, above it, the other profiled strip 43. Bearing respectively against those regions of the peripheral faces 64e, 64f which surround the guide grooves 65 are further sub-portions of the front and rear foil web regions 33a, 34a. The guide grooves 65 are respectively aligned with the guide grooves 59c, 59d of the separating diverter 56.

While the profiled strips 42, 43 are bearing in the previously described manner against the bearing surfaces 59a, 59b or are resting partially in the guide grooves 59c, 59d of the bearing surfaces 59a, 59b of the separating diverter 56, they are welded to the foil web 44. That front region 33a of the foil web 44 which later forms the front wall 33 of the tobacco pouch 30 here bears with its inner side against the carrier strip 42a of the profiled strip 42, namely parallel to the longitudinal top edge of the front foil web region 33a, to be precise somewhat beneath the same.

Similarly, in the welding of the profiled strip 43 to that rear foil web region 34a which later forms the rear wall 34, the inner side of the rear foil web region 34a bears in a suitable manner against the carrier strip 43a of the profiled strip 43.

Within the welding operation, the welding jaws 60a-60f of the welding units 45a-45f are respectively moved in a horizontal motion up to the corresponding foil regions and the profiled strips 42, 43 are welded to the inner sides of the later front wall 33 and rear wall 34 respectively. After this, the welding jaws are moved back. These to and fro motions occur cyclically.

Within the context of the invention, the welding units 45a-45f, too, constitute an independent particularity. For they are configured as ultrasonic welding units. Accordingly, the welding jaws 60a-60f are ultrasonic sonotrodes. In contrast thereto, in pouch packers of the prior art the profiled strips or sealing means are connected to the respective foil webs solely by thermal welding. The strong heat which is here generated gives rise to a number of drawbacks. Firstly, the respective cycle times which are needed for thermal welding are significantly greater compared to ultrasonic welding operations. In addition, the foils expand under the strong heat input in thermal welding, in some cases appreciably. This sometimes led to unwelcome changes of position between the foil web and the sealing means.

Since the ultrasonic sonotrodes 60a-60f also to a certain extent heat up, however, one or more temperature sensors 85 are provided to measure the temperature of the same. When a predefined temperature limit value is reached or exceeded, the power of the ultrasonic sonotrodes 60a-60f is, reduced by means of a suitable control device.

The ultrasonic sonotrodes 60a-60f are powered in the customary manner by ultrasonic generators (not represented) or ultrasonic converters 61-61f connected thereto. These ultrasonic converters 61a-61f are respectively mounted in horizontal planes and are displaceable, together with the sonotrodes 60a-60f, in the horizontal plane from a setting remote from the actual welding position into the welding setting.

In order to prevent the foil regions which are borne against by the hot welding jaws 60a-60f during the welding operation from sticking to these hot welding jaws 60a-60f and being inadvertently carried along in the return motion of these same, or in order to limit such a transport, hold-down means 86a, 86b are optionally provided to both sides of the separating diverter 56. In this instance, these are configured and positioned in such a way that foil regions which might be carried along within the return motion butt against these hold-down means 86a, 86b and, upon the further return motion of the welding jaws 60a-60f, are not further transported beyond the stop plane defined by the respective hold-down means 86a, 86b. The stop plane defined by the respective hold-down means 86a, 86b here extends respectively at a certain distance from the lateral bearing surfaces 59a, 59b of the separating diverter 56, parallel to these. To each bearing surface 59a, 59b there is respectively assigned a hold-down means 86a, 86b. In the present illustrative embodiment, each hold-down means 86a, 86b possesses two mutually spaced hold-down plates, which are guided in the stop plane by means of suitable guide means 87a, 87b. The spacing of the hold-down plates is here chosen such that the welding jaws 60a-60f can move perpendicularly to the stop plane through the obtained free space between the hold-down plates.

A first set of welding units 45a-45c is assigned to one bearing surface 59a, 59b or to one (longitudinal) side of the separating diverter 56, a second set of welding units 45a-45f to the opposite (longitudinal) side of the separating diverter 56. Each set of welding units is here mounted respectively by means of so-called bridge parts 109a-109f respectively on a common support 88a or 88b assigned to the respective separating diverter sides, namely, in this instance, a block of steel. In the present case, the actual ultrasonic generators 61a-61f are positioned within the support.

To each support there is respectively assigned a dedicated linear drive 62a and 62b, namely, in this instance, respectively a compressed-air cylinder, the respective piston rod 89a, 89b of which is fastened to the respective support 88a, 88b. By means of appropriate stroke motions of the respective compressed-air cylinder 62a, 62b, the respective support 88a, 88b and, with it, those welding units 45a-45f of the welding unit sets which are respectively mounted on said support can be displaced in the direction of the respective separating diverter side into the welding setting, and, conversely, away therefrom.

As can be clearly seen, in particular, in FIG. 7, the individual welding units 45a-45f are mounted on a common supporting frame 63. The supporting frame 63 is configured in a C-shaped or C-like design as, in particular, a closed frame, in order to prevent possible deformation by the contact pressure generated during the welding.

In a horizontal plane, two welding units lie respectively opposite each other and form pairs of welding units, namely the welding unit pairs 45a, 45d; 45b, 45e and 45c, 45f. In relation to a vertical center plane running through the separating diverter 56, the individual welding units 45a-45f of the respective welding unit pairs 45a, 45d; 45b, 45e and 45c, 45f are positioned in opposite-lying arrangement in the common horizontal plane. This can clearly be seen from the welding unit pair in FIG. 7.

In order to ensure that, during the welding operation, the mutually opposing welding jaws 60a-60f of a welding unit pair bear respectively with identical pressure against the respective foil region, a synchronizing device 90 or synchronous drive is provided. This synchronizing device 90 ensures that the forward drive or reverse drive motions, in particular of opposing welding unit pairs, which motions are initiated by the compressed-air cylinders 62a, 62b, are mutually coordinated or mutually synchronized, so that, in relation to the center plane of the separating diverter 56, the individual welding jaws 60a-60f of the welding unit pairs are driven synchronously in opposite-running direction up to the respective separating diverter side or away from this.

In the present illustrative embodiment, specifically the motions of the two opposite sets of welding units 45a-45c, on the one hand, and 45d-45f, on the other hand, are synchronized with each other.

In this instance, the synchronizing device 90 possesses, for this purpose, a total of four gearwheels 91a-91d.

A first and a second gearwheel 91a, 91b are arranged in different horizontal planes and are coupled to each other by a common first gear rack 92a running obliquely between the different planes. Here, the two gearwheels 91a, 91b are respectively disposed at opposite end regions of the first gear rack 92a and respectively engage there in corresponding teeth of the first gear rack 92a (FIGS. 6, 7, 8).

The first (in FIG. 7, top left) gearwheel 91a is connected, furthermore, in a rotationally secure manner, by a common, horizontally running, first drive shaft 93a, to a third gearwheel 91c disposed in the same horizontal plane. The first drive shaft 93a here runs perpendicular to the first gear rack 92a. This third gearwheel 91c is coupled by a second gear rack 92b to the first support 88b, which is assigned to the welding unit set 45d-45f and at which the second gear rack 92b ends or to which this is fastened. The second gear rack 92b runs horizontally and at a distance from the first gear rack 92a in a parallel plane. The second gear rack 92b, furthermore, is mounted displaceably in a suitable, fixed linear guide 94a, namely, in this instance, in a suitable bearing sleeve.

The second (in FIG. 7, top right) gearwheel 91b, which is coupled by the common gear rack 92a to the first gearwheel 91a and which is disposed in offset arrangement beneath the first gearwheel 91a, is connected in a rotationally secure manner, by a horizontally running second shaft 93b running parallel to a first shaft 93a, to a fourth gearwheel 91d disposed in the same horizontal plane. The fourth gearwheel 91d, in turn, is coupled by a third gear rack 92c to the second support 88b, which is assigned to the welding unit set 45a-45c and at which the third gear rack 92c ends or to which this is fastened. The third gear rack 92c runs likewise horizontally and at a distance from the first gear rack 92a in a parallel plane, as well as, moreover, parallel to the second gear rack 92b, though in a plane disposed beneath the second gear rack 92b. The third gear rack 92c, furthermore, is likewise mounted displaceably in a suitable, fixed linear guide 94b, namely, in this instance, in a suitable bearing sleeve.

Finally, for suitable parallel guidance of the supports 88a, 88b during the respective forward drive and reverse drive motions, additional, rod-like guide parts 106a, 106b are respectively fastened to the supports 88a, 88b. The rod-like guide part 106a here runs parallel, with spacing, beneath the gear rack 92a, and is mounted displaceably within a linear guide 94c, while the rod-like guide part 106b runs parallel, with spacing, above the gear rack 92c and is mounted displaceably in a linear guide 94d.

In consequence, horizontal motions of the first support 88b which are induced by the compressed-air cylinder 62b are transmitted by the second gear rack 92b fastened to said support initially to the third gearwheel 91c mounted on said gear rack, whereby this gearwheel is set in rotation. As a result, via the common first shaft 93a, the first gearwheel 91a is set in rotation. The rotary motion thereof is translated, in turn, into a horizontal linear motion of the first gear rack 92a. This, in, turn, sets in rotation the second gearwheel 91b mounted on the first gear rack 92a, as well as the fourth gearwheel 91d coupled to said second gearwheel by the second shaft 93b. The coupling of the fourth gearwheel 91d to the second support 88a via the third gear rack 92c ensures a motion which—in relation to the center plane of the separating diverter—runs correspondingly in the opposite direction to the motion of the first support 88b.

As a result of the synchronizing device, the two supports 88a, 88b are displaced at identical speed, even if the two compressed-air cylinders assigned to the respective unit sets produce a forward drive or reverse drive motion which are actually mutually different.

As a departure from the represented synchronizing device, other suitable devices can also naturally be used.

In FIG. 7, the welding jaws or sonotrodes 60a, 60d of the welding units 45a, 45d have been moved up to the welding regions of the foil web 44, so that they are respectively located in the actual welding position. The ultrasonic welding vibrations are then transmitted to the foil web 44 or to the underlying profiled strips 42, 43.

In relation to the vertical center plane through the separating diverter 56, the vibratory motions of the sonotrodes 60a, 60d (as well as of all further sonotrodes of the further welding unit pairs, correspondingly) are preferably mutually coordinated. The sonotrodes 60a, 60d preferably perform, in relation to this vertical center plane, vibratory motions at equal frequency and in same phase, so that, relative to this center plane, they are moved in phase closer together, or up to the separating diverter 56 or away therefrom. This is not absolutely necessary, however.

Optionally, supporting means 95a, 95b for the welding jaws 60a-60f are provided, in the present case, supporting plates. These run likewise in a plane parallel to the lateral bearing surfaces 59a, 59b of the separating diverter 56, respectively at a distance from these bearing surfaces 59a, 59b. To each of these bearing surfaces 59a, 59b there is here assigned at least one supporting means 95a, 95b. Each supporting means is here positioned between the respective bearing surface 59a, 59b and the welding jaws 60a-60f, assigned to the respective bearing surface 59a, 59b, of the welding units 45a-45f. For this purpose, the supporting means 95a, 95b are held correspondingly on suitable retaining elements 96a, 96b. Each supporting means 95a, 95b extends over all of the welding jaws 60a-60f assigned to the respective bearing surface 59a, 59b. As a result of the supporting means 95a, 95b, foil regions, during the welding operation, are prevented from coming to lie in gaps between adjacent welding jaws 60a-60f, whereby corresponding unwanted impressions would be produced on the foils. The supporting means 95a, 95b transmit the ultrasonic motions generated by the welding jaws 60a-60f of a common welding plane to the full face of the foil.

In FIGS. 13-16, an alternative embodiment of the first welding station 45 is shown. The welding units 45a-45f, as well as further basic parts, are unchanged from the embodiment of drawings 6-12.

However, no separating diverter 56 for the mutual separation of the profiled strips 42, 43 is present, since the latter are welded in the mutually connected state to the foil web 44 x. For this, a special bearing device 97 is provided, along which the closed sealing means web 41 is guided or against which the sealing means 41 bears during the welding operation.

The bearing device 97 possesses two bearing means 98a, 98b, which respectively, in the abutting state of the closed sealing means 41, reach from opposite sides between the two mutually connected profiled strips 42, or between the two mutually spaced carrier strips 42a, 43a of the connected profiled strips 42, 43. The carrier strips 42a, 43a bear during the welding operation respectively against opposite sides of the respective bearing means 98a, 98b.

In the present case, the bearing means 98a, 98b are formed by sub-regions of two sheet-metal strips, which are guided by means of a suitable holder 99, with the formation of an interspace 100, in the plane of conveyance of the sealing means web 41. The sealing means web 41 is guided along the interspace 100 between the sheet-metal strips, namely in such a way that the inwardly directed sides of the carrier strips 42a, 43a of the respective profiled strips 42, 43, or the sides thereof which are directed to the respectively other profiled strips 42 and 43, respectively bear at least in some areas against opposite, parallel sides of the respective sheet-metal strip.

The width of the interspace 100 between the bearing means 98a, 98b or between the sheet-metal strips here roughly corresponds to the width of the wider connecting profile of the two profiled strips 42, 43, namely of the connecting profile 43b of the profiled strip 43.

FIGS. 17, 18 show the second welding station 46, at which the opposite end portions 49-52 of the profiled strips 42, 43 are fused together or crashed. Also along this welding station 46, the material webs 41, 44, i.e. the continuous foil strip 44 with profiled strips 42, 43 already welded to the respective web portions, are guided in the vertical direction.

The welding units 46a, 46b and 46c, which are constructed like the welding units 45a, 45b and 45c of the welding station 45, i.e. as ultrasonic welding units, drive up to the foil web 44 for the welding operation. During the following welding operations, the respective portions of the foil web 44 bear against bearing surfaces 70a-70c of anvil-like bearing devices 68a-68c. To each welding unit there is respectively assigned, in the same horizontal plane, a bearing device 68a, 68b and 68c. The bearing surfaces 70a-70c run parallel to the vertical plane of conveyance.

Upstream of the welding units there is arranged a separating diverter 107 for the opening of the sealing means web guided, in the present illustrative embodiment, in the closed state to the second welding station.

Both the bearing devices 68a-68c and the welding units 46a-46c are disposed on a common frame 60.

For the welding of the respective portions 49, 50 and 51, 52 of the profiled strips 42, 43, the respective welding units 46a-46c are displaced into the welding position, similarly to the welding units 45a-45c of the first welding station 45, by means of linear drives 71a-71c. Ultrasonic generators 72a-72c set the respective ultrasonic sonotrodes 73a-73c into the required welding vibrations.

In addition, analogously to the first welding station 45, hold-down means 101a-101c are provided, which, during return motions of the welding jaws 73a-73c, prevent the foil from sticking to the hot welding jaws 73a-73c and being inadvertently carried along, or which limit such a transport. The hold-down means 101a-101c are, in turn, respectively positioned between a welding jaw 73a-73c and the respective bearing surface 70a-70c.

For the adjustment of the vertical positions of the individual welding units 46a-46c, these are vertically displaceable along the foil web 44 by means of an actuator 74. The positions of the sonotrodes 73a-73c relative to the foil web 44 are hence adjustable. In the present illustrative embodiment, the actuator 74 is configured as a manually operable spindle drive with crank handle 75 and spindle 76. The respective welding units 46a-46c are operatively connected to the spindle 76 respectively in a suitable manner.

Alternatively, the individual sets 46a-46c can also be displaced, of course, by means of one or more motor drives.

The spindle 76 has respectively different thread pitches. The individual welding units 46a-46c are respectively assigned to these different thread pitch portions. The vertical spacings of the individual sets 46a-46c are thereby altered relative to each other by actuation of the spindle 76. The units 46a-46c are guided via a circular guide 77a, which runs in the vertical plane and is mounted on the frame 69.

When setting the vertical positions of the individual welding units 46a-46c, it is likewise possible, correspondingly thereto, to alter the position of the bearing devices 68a-68c. For this purpose, the bearing devices 68a-68c are mounted displaceably in a common, vertically running guide groove 77b recessed in the frame 69. By means of suitable fastening means 78a-78c, the bearing devices 68a-68c can be fixed in the respectively desired vertical position.

The individual welding units 46a-46c, as well as the bearing devices 68a-68c, are also upwardly and downwardly adjustable in the vertical plane in their entirety, i.e. without alteration to their relative individual positions.

For this purpose, on the frame 69 there is provided a further actuator 79, with which the entire welding station 46 or the frame 69, with all the units mounted thereon, is upwardly and downwardly adjustable. The actuator 79 likewise possesses a vertically running spindle 80 and a hand wheel 81. That end of the spindle 80 which lies opposite the hand wheel 81 is mounted on a frame 82 of the third welding station 47. The vertical position of the welding station 46 can therefore be set relative to the welding station 47.

The third welding station 47 is constructed very similarly to the second welding station 46 (FIGS. 19-22). For this reason, homogeneous components are provided in the corresponding drawings with the same reference numerals. At this welding station 47, the cross seams 35 of the pouches 30 are welded.

The third welding station 47 has, unlike the welding station 46, a main frame 82a, on which a C-shaped or C-like sub-frame 82b, which is horizontally adjustable relative to the main frame 82a, to be precise transversely to the welding direction, is disposed.

The adjustability of the sub-frame 82b relative to the main frame 82a is in this instance achieved by the sub-frame 82b being fastened to the main frame 82a with suitable fastening means 103a, 103b, for instance screws, reaching through slots 102a, 102b in the sub-frame 82b. The longitudinal extent of the slots 102a, 102b here runs horizontally, namely in the direction transversely to the welding direction or to the direction of motion of the welding jaws 73a-73c. When different pouch formats or different foil formats are used, this serves to be able to alter the position of the welding units 47a-47c jointly with the bearing devices 68a-68c relative to the foil 44 (FIG. 21).

Analogously, it is further envisaged to mount the respective anvil-like bearing devices 68a-68c such that they are additionally displaceable relative to the sub-frame 82b in the horizontal plane, namely likewise transversely to the welding direction.

When different pouch formats or different foil formats are used, this serves to be able to adjust the position of the bearing devices 68a-68c correspondingly, in a suitable manner, relative to the welding units 47a-47c or welding jaws 73a-73c, or to the foil 44.

To this end, the bearing devices 68a-68c, in the present illustrative embodiments, are fastened to the sub-frame 82b by means of suitable fastening means 103c, 103d reaching through slots 102c, 102d in the respective bearing device 68a-68c. The longitudinal extent of the slots 102c, 102d likewise runs horizontally, namely in the direction transversely to the welding direction or to the direction of motion of the welding jaws 73a-73c.

The free ends 108a, 108b of the sub-frame 82b are braced by a tensioning means 83. The tensioning means 83 comprises a tie rod 83a. The tie rod 83a is mounted displaceably on one free end 108a of the sub-frame 82, is fastened detachably to the other free end 108b by means of a fastening lever 84. If need be, the tie rod 83a can therefore be released and moved out of the vertical path of conveyance (FIG. 22). The obtained free space can be used to thread the foil web 44 in a simple manner, starting from the free ends 108a, 108b, between the respective sonotrode 73a-73c, on the one hand, and the respective bearing surface 70a-70c, on the other hand.

In FIGS. 23-25, a further alternative to the embodiment of FIG. 1 is shown.

In contrast to the embodiment of FIG. 1, the welding station 46 for fusing the end portions 49, 50 of the profiled strips 42, 43, and the station 47 for welding the cross seams 35 of the foil web 44, are here combined in a common welding station 104. The fusion of the end portions 49, 50 and 51, 52 and the welding of the cross seams 35 take place concurrently.

For this purpose, the welding units 46a-46c and 47a-47c are disposed jointly on a C-shaped or C-like sub-frame 82b. Also mounted on this latter are the respective bearing devices. For better differentiability, the reference symbols of the bearing devices of the welding units 47a-47c and of the welding jaws are additionally labeled with a “'”.

In, respectively, a horizontal plane, pairs 46a, 47a; 46b, 47b and 46c, 47c of welding units 46a-46c for fusing the profiled strips 49-52 or of welding units 47a-47c for cross seam welding are formed. The three pairs 46a, 47a; 46b, 47b and 46c, 47c of welding units in total are respectively arranged downstream one below the other. Correspondingly, the bearing devices 68a-68c and 68a′-68c′ are assigned to the respective welding units in mutually opposite arrangement.

The welding units of a pair, for instance the welding units 46a, 47a, are arranged mutually offset in relation to the foil web 44, cf. FIG. 25. The welding units for cross seam welding 47a-47c, as well as the welding units 46a-46c, in particular the respective welding jaws of the units 46a- . . . -47c, are here positioned such that the respectively welded cross seam 35 ends relative to the bottom edge 32 beneath the end portions 49, 50 and 51, 52 to be fused.

All welding units are movable jointly with the corresponding bearing devices 68a-68c and 68a′-68c′ relative to the foil web, namely by the correspondingly configured spindle drive 79.

### REFERENCE SYMBOL LIST

30 pouch

31 tobacco portion

32 bottom edge

33 front wall

33a front foil region

34 rear wall

34a rear foil region

35 cross seam

36a side seam

36b side seam

37 envelope flap

38 adhesive strip

39 fill/removal opening

40 longitudinal seam

41 sealing means

42 profiled strip

42a carrier strip

42b connecting profile

43 profiled strip

43a carrier strip

43b connecting profile

44 material web

45 welding station

45a welding unit

45b welding unit

45c welding unit

45d welding unit

45e welding unit

45f welding unit

46 welding station

46a welding unit

46b welding unit

46c welding unit

47 welding station

47a welding unit

47b welding unit

47c welding unit

48 folding device

49 end portion

50 end portion

51 end portion

52 end portion

53 folding triangle

54a guide roller

54b guide roller

55 guide gap

56 separating diverter

57a free end

57b free end

58 deflection roller

59a lateral bearing surface

59b lateral bearing surface

59c guide groove

59d guide groove

60a welding jaw

60b welding jaw

60c welding jaw

60d welding jaw

60e welding jaw

60f welding jaw

61a ultrasonic generator

61b ultrasonic generator

61c ultrasonic generator

61d ultrasonic generator

61e ultrasonic generator

61f ultrasonic generator

62a linear drive

62b linear drive

63 supporting frame

64a guide roll

64b guide roll

64c guide roll

64d guide roll

64e peripheral face

64f peripheral face

65 guide groove

66 draw roll

67 deflection roller

68a bearing device

68b bearing device

68c bearing device

69 frame

70a bearing surface

70b bearing surface

70c bearing surface

71a linear drive

71b linear drive

71c linear drive

72a ultrasonic generator

72b ultrasonic generator

72c ultrasonic generator

73a welding jaw

73b welding jaw

73c welding jaw

74 actuator

75 crank handle

76 spindle

77a circular guide

77b guide groove

78a fastening means

78b fastening means

78c fastening means

79 actuator

80 spindle

81 hand wheel

82 frame

82a free end

82b free end

83 tensioning means

83a tie bar

84 fastening lever

85 temperature sensor

86a hold-down means

86b hold-down means

87a guide means

87b guide means

88a support

88b support

89a piston rod

89b piston rod

90 synchronizing device

91a gearwheel

91b gearwheel

91c gearwheel

91d gearwheel

92a gear rack

92b gear rack

92c gear rack

93a drive shaft

93b drive shaft

94a linear guide

94b linear guide

94c linear guide

94d linear guide

95a supporting means

95b supporting means

96a retaining element

96b retaining element

97 bearing device

98a bearing means

98b bearing means

99 holder

100 interspace

101a hold-down means

101b hold-down means

101c hold-down means

102a slot

102b slot

103a fastening means

103b fastening means

103c fastening means

103d fastening means

104 welding station

105 printed mark reader

106a guide part

106b guide part

107 separating diverter

108a free end

108b free end

109a bridge part

109b bridge part

109c bridge part

109d bridge part

109e bridge part

109f bridge part

1. Method for the manufacture of pouches (30) from foil (44) or the like for bulk goods or fibrous material, preferably for tobacco (31), wherein a continuous foil web (44) and/or at least one further continuous material web (41) are guided along at least one welding station (45, 46, 47, 104), at which portions of the foil (33a) (and/or of the at least one further material (41) are welded, preferably to other portions of the foil (34a) and/or to the further material (41), in particular to parts of a multiaction sealing means (41), characterized in that the foil web (44) and/or the at least one further material web (41) are guided, in particular cyclically, at least approximately in a vertical direction along the at least one welding station (45, 46, 47, 104), and/or in that the continuous foil web (44) and/or the at least one further material web (41) are welded, in particular cyclically, by ultrasonic welding.

2. Method according to claim 1, characterized in that the or each welding station (45, 46, 47, 104) has welding jaws (60a, . . . ), in particular ultrasonic sonotrodes, which in a horizontal plane are respectively moved up to at least one of the materials (41, 44) to be welded, so that the welding jaws (60a, . . . ), during the actual welding operation, particularly during the application of pressure, bear against the respective material (41, 44).

3. Method according to at least one or more of the preceding claims, characterized in that at least two, preferably three and/or all welding stations (45, 46, 47, 104), are arranged in a common vertical plane consecutively in the direction of conveyance of the foil web, preferably one below the other.

4. Method according to one or more of the preceding claims, characterized in that preferably at a first welding station (45), a multiaction pressure seal, as the sealing means (41), is fastened to the foil web (44), preferably by ultrasonic welding.

5. Method according to one or more of the preceding claims, characterized in that, in particular at a second welding station (46), which is preferably arranged downstream of the first welding station (45), individual portions (49-52) of profiled strips (42, 43) of the pressure seal (41) are fused or welded together, preferably by ultrasonic welding, and/or in that, in particular at a third welding station (47), which is preferably arranged downstream of the second welding station (46), individual portions (33a, 34a) of the foil are welded together, preferably by ultrasonic welding, with the formation of cross seams (35) extending substantially transversely to the direction of conveyance of the foil web (44).

6. Method according to one or more of the preceding claims, characterized in that the foil web (44) is guided without deflection between the welding stations (45, 56, 47, 104) rectilinearly in an at least approximately vertical direction along at least two, preferably along all welding stations (45, 46, 47, 104).

7. Method according to claim 4, characterized in that the pressure seal (41) has two profiled strips (42, 43), which can be detachably connected to each other and which, as continuous profiled strips (42, 43), in the mutually connected state, namely the closed state of the pressure seal (41), are fed into the path of conveyance of the foil web (44), which are subsequently separated—opened state of the pressure seal (41)—and which subsequently, in the separated state, are respectively welded individually to the foil (44).

8. Method according to claim 7, characterized in that the pressure seal (41), for the separation of the connected profiled strips (42, 43), is conveyed to a separating diverter (56), which separates the pressure seal (41) into the two profiled strips (42, 43), whereupon the two profiled strips (42, 43), following the separation and prior to the welding of the same, are conveyed onward along the separating diverter (56), and/or in that the separating diverter (56) has to both sides bearing surfaces (59a, 59b), against which the separated profiled strips (42, 43) bear during the welding operation, the welding jaws (45a-45f) of the welding station (45) being arranged opposite to the bearing surfaces (59a, 59b).

9. Method according to one or more of the preceding claims, characterized in that the position of the continuous foil web (44) and/or of the pressure seal (41) is registered by means of a suitable sensor (105), in particular by means of a printed mark reader, and in that the position of the foil web (44) relative to the welding jaws (60a, . . . ) of at least one welding station (45, 46, 47, 104) is controlled and/or regulated in dependence on the measurement values registered by the sensor (105).

10. Method according to one or more of the preceding claims, characterized in that respectively two welding jaws (60a, . . . ), in particular ultrasonic sonotrodes, are arranged opposite each other in a horizontal plane, and in that the welding jaws (60a, . . . ), in particular during the welding operation, are moved uniformly up to or away from each other in relation to a vertical center plane running between the welding jaws (60a, . . . ), these motions being mutually synchronized by means of a suitable synchronizing device (90).

11. Apparatus for the manufacture of pouches (30) from foil or the like for bulk goods or fibrous material, preferably for tobacco (31), preferably for implementation of the method according to claim 1, in particular having one or more features of claims 1-10, comprising a conveying device with which a continuous foil web (44) and/or a further continuous material web (41) can be guided along at least one welding station (45, 46, 47, 104) of the apparatus, wherein the welding station (45, 46, 47, 104) is configured such that, at this, portions (33a) of the foil and/or of the at least one further material (41) can be welded, preferably to other portions (34a) of the foil and/or to the further material (41), in particular to parts of a multiaction sealing means (41), characterized in that the conveying device and the welding station (45, 46, 47, 104) are configured and arranged such that the foil web (44) can be guided along the at least one welding station (45, 46, 47, 104) at least approximately in a vertical direction, and/or in that the welding station is configured as an ultrasonic welding station.

12. Apparatus according to claim 11, characterized in that the welding station (45, 46, 47, 104) has welding jaws (60a, . . . ), in particular ultrasonic sonotrodes, which are arranged such that they are movable in an at least approximately horizontal plane, in particular driven by a motor drive (62a-f, 71a-c), for instance a hydraulic or pneumatic drive.

13. Apparatus according to one or more of the preceding claims 11-12, characterized in that at least two, preferably three and/or all welding stations (45, 46, 47, 104), are arranged consecutively downstream of one another in a common vertical plane in the direction of conveyance of the foil web, preferably one below the other.

14. Apparatus according to one or more of the preceding claims 11-13, characterized in that at least one welding station (45, 56, 47, 104) possesses a plurality of welding units (45a, . . . ), arranged consecutively downstream of one another and arranged, in particular, one below the other in a vertical plane and respectively having at least one welding jaw (60a, . . . ), in particular an ultrasonic sonotrode, the welding units (45a, . . . ) of the welding station being disposed on a common frame (63, 69) or rack, preferably on a closed frame/rack.

15. Apparatus according to one or more of the preceding claims 11-14, characterized in that at least one welding station (45, 46, 47, 104) possesses a plurality of welding unit pairs (45a, . . . ), in particular arranged one below the other in the vertical plane and respectively having at least one welding jaw (60a, . . . ), the welding units (45a, . . . ) of a welding unit pair (45a, 45d; 45b, 45e; . . . ) being positioned one opposite the other in relation to the feed motion of the foil web (44) at a common feed position and in relation to a center plane between the welding units (45a, . . . ), in particular in a common horizontal plane.
